(19) United States
(12) Patent Application Publication
(10) Pub. No.: US 2013/0301280 A1
(43) Pub. Date: Nov. 14, 2013

(54) Bulb-Shaped Lamp and Luminaire

(71) Applicant: TOSHIBA LIGHTING & TECHNOLOGY CORPORATION, Yokosuka-shi (JP)

(72) Inventors: Ryotaro Matsuda, Yokosuka-shi (JP); Naoto Mori, Yokosuka-shi (JP); Jun Sasaki, Yokosuka-shi (JP); Yoshiyuki Matsunaga, Yokosuka-shi (JP); Hideki Okawa, Yokosuka-shi (JP); Takeo Yasuda, Yokosuka-shi (JP)

(73) Assignee: Toshiba Lighting & Technology Corporation, Yokosuka-shi (JP)

(21) Appl. No.: 13/783,975

(22) Filed: Mar. 4, 2013

(30) Foreign Application Priority Data
May 11, 2012 (JP) 2012-109649

(51) Int. Cl. F21V 29/00; F21V 3/00

(52) U.S. Cl. CPC F21V 29/004; F21V 3/00
USPC 362/363

(57) ABSTRACT

According to one embodiment, a bulb-shaped lamp includes a light source unit, a plurality of substrates, a substrate holding member, and a globe. The respective substrates hold light source units. The substrate holding member has thermal conductivity and an insulating property and holds the respective substrates. The globe is thermally connected to the substrate holding member. The cap is positioned on one end side of the globe.

### INCORPORATION BY REFERENCE

The present invention claims priority under 35 U.S.C. §119 to Japanese Patent Application No. 2012-109649 filed on May 11, 2012. The content of the application is incorporated herein by reference in their entirety.

### FIELD

Embodiments described herein relate generally to a bulb-shaped lamp having a globe, and a luminaire having the same.

### BACKGROUND

In the related art, there is a bulb-shaped lamp which may be used instead of an incandescent lamp and using a fluorescent lamp as a light source. In addition, in recent years, there is also a bulb-shaped lamp using an LED as alight source. Such a bulb-shaped lamp includes a substrate including LED elements mounted thereon and forming a light source, and includes a globe mounted so as to cover the substrate.

### BRIEF DESCRIPTION OF THE DRAWINGS

FIG. 1 is a perspective view illustrating part of a bulb-shaped lamp of a first embodiment in a deployed mode;

FIG. 2 is a plan view illustrating the part of the same lamp in the deployed mode;

FIG. 3 is a perspective view of the same lamp;

FIG. 4 is an explanatory drawing illustrating a luminaire of the same lamp;

FIG. 5 is an explanatory cross-sectional view schematically illustrating an example of a thermal distribution of the same lamp;

FIGS. 6(a) and 6(b) are explanatory perspective views schematically illustrating the example of the thermal distribution of the same lamp, in which FIG. 6(a) illustrates the thermal distribution of an outside of the lamp, and FIG. 6(b) illustrates the thermal distribution of an interior of a globe of the lamp;

FIG. 7 is an explanatory cross-sectional view illustrating a bulb-shaped lamp according to a second embodiment;

FIG. 8 is a perspective view illustrating part of the same lamp in a deployed mode;

FIG. 9 is an explanatory cross-sectional view schematically illustrating an example of a thermal distribution of the same lamp; and

FIGS. 10(a) and 10(b) are perspective views schematically illustrating the example of the thermal distribution of the same lamp, in which FIG. 10 (a) illustrates the thermal distribution of an outside of the lamp, and FIG. 10(b) illustrates the thermal distribution of an interior of a globe of the lamp.

### DETAILED DESCRIPTION

A bulb-shaped lamp of embodiments includes a light source unit, a plurality of substrates, a substrate holding member, a globe, and a cap. The substrates each hold the light source unit. The substrate holding member has thermal conductivity and holds the respective substrates in the periphery thereof. The globe comes into contact with the substrate holding member. The cap is positioned on one end side of the globe.

A configuration of the first embodiment will be described below with reference to the drawings.

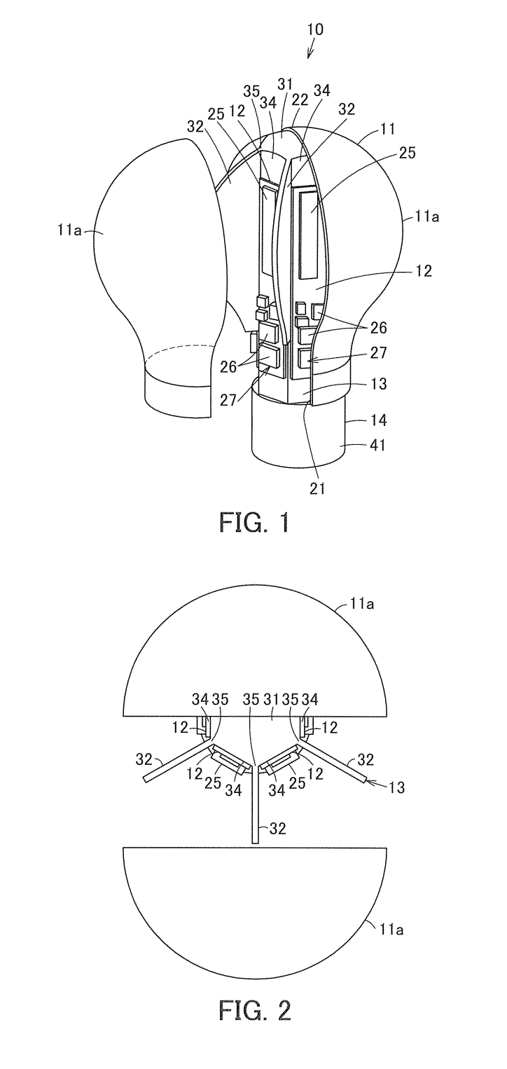

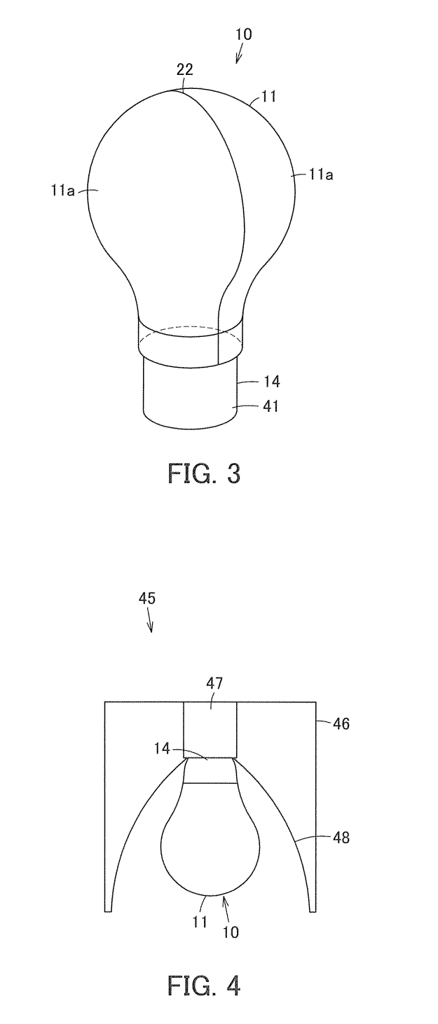

In FIG. 1 to FIG. 6, reference numeral 10 denotes a bulb-shaped lamp. The bulb-shaped lamp 10 includes a globe 11, a plurality of substrates 12 and a substrate holding member 13 housed in the globe 11, and a cap 14 mounted on one end portion of the globe 11.

The globe 11 is formed of a thermal resistant material such as a synthetic resin or glass having a transmissivity of, for example, 80 to 95% (of light-transmissivity), and has a shape of a rotating body having an opening 21 on one end side and the other end side formed into a spherical shape, and having a center axis, which is a straight line, passing through a center portion of the opening 21 and a top portion 22 on the other end side thereof. The globe 11 has a length in the direction of the lamp axis, which is the center axis and an outer diameter of a maximum diameter portion in the direction intersecting the direction of the lamp axis, which are the same as those of an incandescent lamp for general lighting, and has a shape approximate to an incandescent lamp as a whole. In addition, the globe 11 is divided vertically into two of the divided parts 11a and 11a by a plane including the top portion 22 and the lamp axis, and is configured by combining these divided parts 11a and 11a without forming a gap.

The substrates 12 are each formed into an elongated square shape, that is, into a reed shape, and a light source unit 25 which has a form of a surface light source is provided on one end side of one main surface of a substrate 12, and a plurality of circuit elements 26 are mounted on the other end side thereof, thereby constituting a light source circuit unit 27 configured to supply power to the light source units 25. In other words, each of the substrates 12 constitutes an LED light source circuit module including the light source unit 25 and the light source circuit unit 27 corresponding thereto integrally mounted on the substrate 12. The substrates 12 are held by being thermally connected on the back sides thereof, which are the other main surfaces thereof, to the substrate holding member 13 via a thermal radiation silicone or the like, as a thermal conductive member. The substrates 12 and the substrate holding member 13 may be insulated from each other by providing the thermal radiating silicone with an insulating property.

The light source units 25 are each formed as the elongated surface light source extending along the longitudinal direction of the substrate 12 with semiconductor light-emitting elements such as LED elements or EL elements. In this embodiment, the LED elements are used as the semiconductor light-emitting elements, and a COB (Chip On Board) system on which a plurality of the LED elements are mounted on the substrate 12 is employed. In other words, the plurality of LED elements are mounted on the substrate 12, and the plurality of LED elements are electrically connected in series via wire bonding. The plurality of LED elements are integrally covered with a phosphor layer which is formed of a transparent resin such as a silicone resin in which phosphor is mixed therein. The LED elements configured to emit blue light, for example, are used as the LED elements, and the phosphorous layer includes phosphor which radiates yellow light by being excited by part of the blue light from the LED elements mixed therein. Therefore, the light source units 25 each constitute the surface light source composed of the LED elements, the phosphorous layer, and the like, and the surface of the phosphor layer as a surface thereof corresponds to a light-emitting surface. White illuminating light is radiated from the light-emitting surface. The amount of light of the light source units 25 per piece of the substrate 12 is set to be the same constant value among the substrates 12 for example, and the amount of light of the bulb-type lamp 10 is set by changing the number of pieces of the substrates 12 to be used. In other words, the number of pieces of the substrates 12 used in the bulb-type lamp 10 of this embodiment is set to be plural numbers of three or more corresponding to the intended amount of light.

The circuit elements 26 each include a capacitor, a switching element, a diode, and a resistor of various types, and are configured so that the light source circuit unit 27 forms a constant current circuit configured to output a constant current to the light source unit 25.

The substrate holding member 13 is formed integrally of a thermal resistant member having predetermined thermal conductivity of 5 to 30 W/m·K, for example, and a predetermined insulating property of 5 to 20 kV, and includes a holding member body 31 configured to hold the substrate 12, and a plurality of fins 32 protruding from the holding member body 31. The surface of the substrate holding member 13 is preferably processed so as to reflect and diffuse light from the light source units 25.

The holding member body 31 is formed into an elongated shape, is a hexagonal shape in plan view (viewed in the axial direction) for example, and is arranged along the lamp axis. In other words, the holding member body 31 includes a plurality of (six) surface portions 34 extending in parallel to the lamp axis and having substantially the same surface areas with respect to each other around the lamp axis, and portions between the surface portions 34 and 34 correspond to corner portions 35. The surface portions 34 are apart from each other substantially equidistantly (at substantially regular angular intervals) in the circumferential direction with respect to the lamp axis, and the substrates 12 are held thereon in a state of being thermally connected respectively. Therefore, the respective substrates 12 are arranged in the vertical direction along the direction of the lamp axis, respectively, and are mounted so as, in a sense, to be wound around the substrate holding member 13, so that the direction of the plane of the one substrate 12 and the direction of the plane of another substrate 12 adjacent to the one substrate 12 form a predetermined angle (an angle between the surface portions 34 and 34 of the holding member body 31). In addition, a proximal end side, which corresponds to one end side of the holding member body 31, is inserted into and fixed to the interior of the cap 14 and is thermally connected to the cap 14, and at a distal end side, which corresponds to the other end side, is tightly in contact with and thermally connected to an inner surface on the other end side including the top portion 22 of the globe 11. The respective substrates 12 are held at positions deviated toward the proximal end side with respect to the distal end portion of the holding member body 31, respectively. In other words, the respective substrates 12 are at positions apart from the inner surface in the vicinity of the top portion 22 of the globe 11. The light source units 25 of the respective substrates 12 are arranged at positions including a maximum diameter portion of the globe 11 in the direction of the lamp axis, and the light source circuit units 27 are arranged in the vicinity of the cap 14. In other words, the light source units 25 of the respective substrates 12 are arranged so as to extend toward one end side and the other end side with respect to the maximum diameter portion of the globe 11 in the direction of the lamp axis.

The respective fins 32 protrude along the radial direction intersecting (orthogonal to) the lamp axis direction from each of the corner portions 35 of the holding member body 31. In other words, the fins 32 extend in the radial direction in plan view (viewed in the axial direction), are apart from each other circumferentially of the lamp axis substantially equidistantly (substantially the same angle) and are located along the both long sides of the respective substrates 12. Furthermore, the fins 32 continue from the distal end side to the proximal end side of the holding member body 31 along the longitudinal direction, the entire part of outer edges are brought into planarly tight contact to an inner surface including the maximum diameter portion of the globe 11 and is thermally connected to the globe 11. Therefore, the fins 32 have a shape having the curved outer edge and extending along the curved inner surface of the globe 11. Furthermore, the fins 32 continue to a position extending from the light source units 25 of the respective substrates 12 to the light source circuit units 27 held by the respective surface portions 34 of the holding member body 31.

The shape of the holding member body 31 in plan view (viewed in the axial direction) may be set as needed corresponding to the number of the substrates 12 used for the bulb-type lamp 10. In other words, if the number of the substrate 12 to be used is four, for example, the holding member body 31 may be formed into a rectangular shape (square shape) in plan view (viewed in the axial direction). Therefore, the fins 32 may be set corresponding to the number of the substrates 12 (to the same number as the number of the substrates 12).

The cap 14 is connected to a socket for a general illuminating bulb and is configured to be capable of supplying power from an external power source. An end portion side is inserted into the opening 21 of the globe 11, so that the opening 21 is closed. The cap 14 includes a shell portion 41 formed of a member such as a conductive metal or the like into a bottomed cylindrical shape, an insulating portion 42 provided on the other end side of the shell portion 41, and an eyelet 43 provided at a top portion of the insulating portion 42. The shell portion 41 and the eyelet 43 of the cap 14 are electrically connected to the light source circuit units 27 of the respective substrates 12 via lead wires or the like, not illustrated, respectively.

When designing the bulb-type lamp 10, the number of the substrates 12 is determined by dividing an intended amount of light by the amount of light from the light source unit 25 per piece of the substrate 12 as a first step. Subsequently, the number of the surface portions 34 of the holding member body 31 of the substrate holding member 13 and the number of the fins 32 are determined corresponding to the determined number of the substrates 12. Furthermore, the substrate holding member 13 determines the lengths or the outer shapes of the holding member body 31 and the fins 32 corresponding to the size of the substrates 12 and the size of the globe 11.

When assembling the bulb-type lamp 10, the other main surfaces of the substrates 12 on which the light source units 25 and the light source circuit units 27 are mounted in advance are held on the respective surface portions 34 of the substrate holding member 13 molded in advance according to the design so as to connect thermally to each other respectively. Subsequently, the one end side of the holding member body 31 of the substrate holding member 13 holding the substrates 12 is inserted into and fixed to the cap 14 configured in advance. In addition, the shell portion 41 and the eyelet 43 of the cap 14 are electrically connected to the light source circuit units 27 of the respective substrates 12 by lead wires, respectively. Then, the divided parts 11a and 11a are assembled from both sides of the substrate holding member 13 and the cap 14 and are fixed to each other, so that the bulb-type lamp 10 is completed. In this state, the inner surface of the globe 11 is thermally connected to the distal end portion of the holding member body 31 of the substrate holding member 13 and the fins 32 in tight contact with each other.

FIG. 4 illustrates a luminaire 45, which is a downlight using the bulb-type lamp 10. The luminaire 45 includes a luminaire body 46, and a socket 47 in which the bulb-type lamp 10 is to be mounted, and a reflector 48 configured to reflect light radiated from the bulb-type lamp 10 downward are disposed in the luminaire body 46.

When the bulb-type lamp 10 is mounted in the socket 47 of the luminaire 45 and is energized, the light source circuit units 27 of the respective substrates 12 are activated, power is supplied to a plurality of LED chips of the light source units 25 to turn on the plurality of LED chips so that light is radiated from the light source units 25. The light radiated from the light source units 25 passes through the globe 11 and is radiated to the outside while being reflected and diffused by the substrate holding member 13.

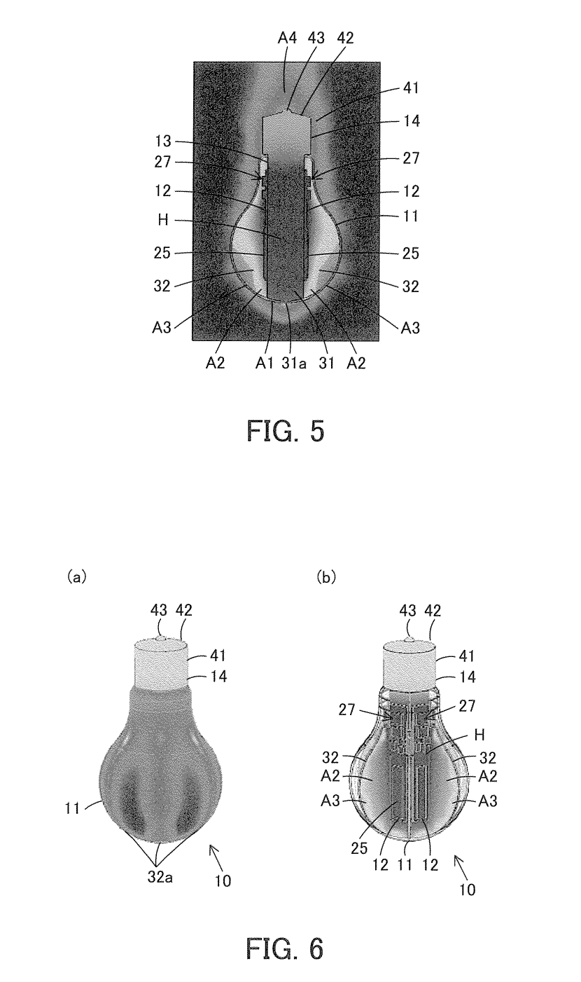

Heat generated when the plurality of LED chips of the respective substrates 12 are turned on, and heat generated from the circuit elements 26 by the operation of the light source circuit units 27 are mainly conducted to the substrates 12, and is conducted from the substrates 12 to the substrate holding member 13, then is conducted from the holding member body 31 and the respective fins 32 of the substrate holding member 13 to the globe 11 and the cap 14, and is radiated from a position 31a corresponding to the end portion of the holding member body 31 on the surface of the globe 11, positions 32a corresponding to the respective fins 32, and the cap 14 into the air (FIG. 5, FIG. 6A, and FIG. 6B). In other words, the heat is radiated from heat generating area H at a center portion corresponding to the light source units 25 and the light source circuit units 27 where heat generation occurs most, via the distal end portion of the holding member body 31 of the substrate holding member 13, from the position 31a on the surface of the globe 11 to the outside air (area A1), and heat is conducted from the holding member body 31 side as a proximal end side of the respective fins 32 to the globe 11 side as a distal end side thereof while being cooled gradually (areas A2 and A3), and is radiated to the outside air from the positions 32a on the surface of the globe 11. The heat is conducted from the heat generating area H to the cap 14, and is radiated from the cap 14 to the outside air (area A4).

In this manner, by holding the substrates 12 holding the light source units 25 set to the predetermined amount of light around the substrate holding member 13, the bulb-shaped lamp 10 is capable of obtaining the intended amount of light easily by adjusting the number of the substrates 12 to be held on the substrate holding member 13, and designing in a short time is enabled in comparison with a case where the circuit is individually designed corresponding to improvement of light-emitting efficiency of the light source units 25 and the like. Also, by conducting the heat of the respective substrates 12 to the globe 11 by the substrate holding member 13 and radiating the heat from the surface of the globe 11, a desirable heat radiating property is achieved.

Furthermore, by providing the substrate holding member 13 with the fins 32 protruding corresponding to the number of the substrates 12 held thereon, adjustment of the required amount of heat radiation is achieved by the number of the fins 32, and by thermally connecting the fins 32 to the globe 11 by bringing the same into contact therewith, the heat may be reliably conducted from the respective fins 32 to the globe 11, whereby the heat may be radiated from the surface of the globe 11 and thermal design is achieved easily.

In addition, the globe 11 and the substrate 12 may be used commonly irrespective of characteristics of the bulb-type lamp 10, and hence further cost reduction is achieved.

When supplying power to the light source units of the respective substrates by the common power source circuit unit, for example, the adjustment of the output from the power source circuit unit is required corresponding to the adjustment of the number of the substrates. In contrast, by mounting the light source circuit units 27 respectively on the substrates 12, adjustment of the output on the side of the light source circuit units 27 is not required even when the number of substrates 12 is adjusted for an adjustment of the light amount, and hence designing in the shorter time is enabled.

Furthermore, by holding the substrates 12 on the respective surface portions 34 of the holding member body 31 of the substrate holding member 13, the light source units 25 of the respective substrates 12 are arranged over the entire circumferential direction of the globe 11, so that a wide light distribution angle is achieved.

With the provision of the bulb-type lamp 10 configured as described above, the luminaire 45 which is easy to design, provides a desirable heat radiating property and light-distributing characteristics, and being low in cost may be provided.

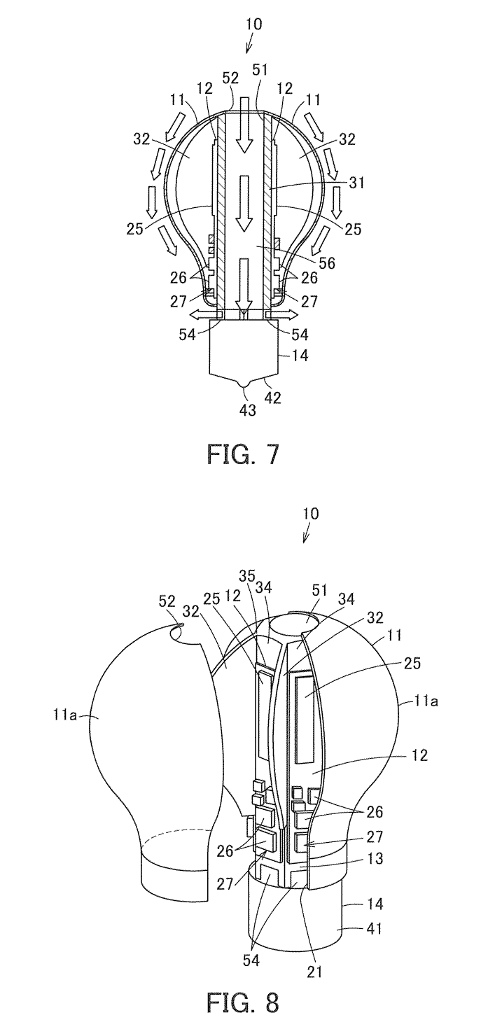

Subsequently, FIG. 7 to FIG. 10 illustrate a second embodiment. The same configuration and operation as those of the embodiment described above are denoted by the same reference numerals and the description thereof is omitted.

The substrate holding member 13 includes a hole portion 51, which is a through hole (center hole) at a center portion of the holding member body 31. In other words, the holding member body 31 is formed into a cylindrical shape. The hole portion 51 has an opening diameter of, for example, 8 to 16 mm, is connected to a communicating opening portion 52 opening in the top portion 22 of the globe 11, and communicates with the outside of the globe 11. Openings 54 communicating respectively with the hole portion 51 are opened at positions between the opening 21 of the globe 11 and the cap 14 at proximal end portions of the respective surface portions 34 of the holding member body 31 of the substrate holding member 13. The openings 54 are exposed to the outside between the one end side of the globe 11 and the cap 14. Therefore, the bulb-type lamp 10 is formed with air-ventilating air trunk 56 communicating with the respective openings 54 from the communicating opening portion 52 via the hole portion 51.

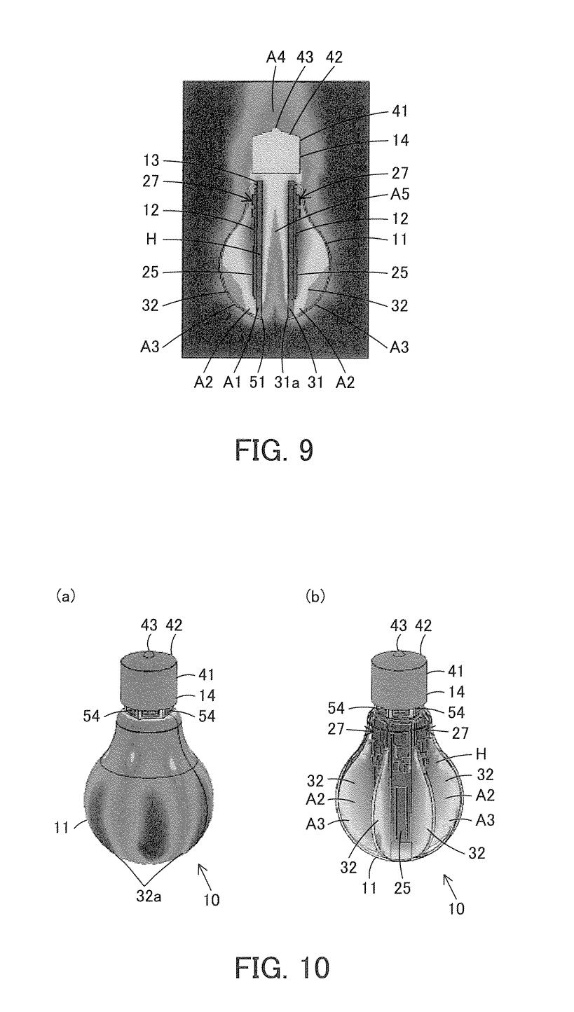

Heat generated when the plurality of LED chips of the respective substrates 12 are turned on, and heat generated from the circuit elements 26 by the operation of the light source circuit units 27 are mainly conducted to the substrates 12, and is conducted from the substrate 12 to the substrate holding member 13, then is conducted from the holding member body 31 and the respective fins 32 of the substrate holding member 13 to the globe 11 and the cap 14, and is radiated from the position 31a corresponding to an end portion of the holding member body 31 on the surface of the globe 11 (a peripheral edge portion of the hole portion 51), the positions 32a corresponding to the respective fins 32, and the cap 14 into the air (FIG. 9, FIG. 10 (a), and FIG. 10 (b)). As illustrated by arrows in FIG. 7, cooling fluid (outside air) flows into the air-ventilating air trunk 56 from the communicating opening portion 52 of the globe 11, and the cooling fluid passes through the interior of the holding member body 31 of the substrate holding member 13 via the hole portion 51, and is exhausted from the respective openings 54, whereby the above-described heat is released to the cooling fluid. In other words, the heat is radiated from the heat generating area H at a center portion corresponding to the light source units 25 and the light source circuit units 27 where heat generation occurs most, via the distal end portion of the holding member body 31 of the substrate holding member 13 from the position 31a on the surface of the globe 11 to the outside air (area A1), and heat is conducted from the holding member body 31 side as the proximal end side of the respective fins 32 to the globe 11 side as the distal end side thereof while being cooled gradually (the areas A2 and A3), and is radiated to the outside air from the positions 32a on the surface of the globe 11. The heat is conducted from the heat generating area H to the cap 14, and is radiated from the cap 14 to the outside air (the area A4). In addition, the outside air (cooling fluid) enters the interior of the heat generating area H from the hole portion 51 to form a cooling area A5, whereby the heat in the heat generating area H is released.

In this manner, by providing the hole portion 51 communicating with the outside of the globe 11 and taking the outside air in the interior on the substrate holding member 13, the heat is released to the outside air taken from the hole portion 51, so that heat radiation is achieved further effectively.

In particular, by providing the hole portion 51 along the center portion of the holding member body 31, the outside air (cooling fluid) may be flowed over the entire portion of the holding member body 31, so that heat radiation is achieved further effectively.

In addition, since the substrate holding member 13 is provided with the openings 54 on the proximal end side to configure the air-ventilating air trunk 56 communicating with the hole portion 51, the outside air (cooling fluid) may be passed through the interior of the air-ventilating air trunk 56 reliably without being accumulated in the hole portion 51, so that the heat radiation is achieved further effectively.

In the respective embodiments described above, if the respective substrates 12 are configured to be held on the periphery of the substrate holding member 13 via predetermined insulating members, the substrate holding member 13 may be formed of a material having no insulating property. Therefore, the substrate holding member 13 may be formed of a metal superior in thermal radiating property for example, or may be formed of a synthetic resin or ceramic superior in moldability.

The light source circuit units 27 may be configured by mounting the entire circuits on the respective substrates 12 or mounting partly such as a common part of the respective circuits (for example, a rectification circuit) on a separate substrate. In other words, the light source circuit units 27 may be mounted at least partly on the respective substrates 12.

Furthermore, the configuration of the fins 32 of the substrate holding member 13 is not limited to being in tight contact at outer edges thereof with the inner surface of the globe 11. Alternatively, a configuration in which opening portions are formed on the globe 11, and outer edge sides of the fins 32 are inserted into and fitted to the opening portions so as to be exposed to the outside of the globe 11 is also applicable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bulb-shaped lamp comprising:
light source units;
a plurality of substrates configured to hold the light source units respectively;
a substrate holding member having thermal conductivity and configured to hold the respective substrates on a periphery thereof;
a globe configured to come into contact with the substrate holding member; and
a cap positioned on one end side of the globe.

2. The lamp according to claim 1, wherein the substrate holding member includes fins protruding corresponding to the number of substrates held thereby and configured to come into contact with the globe.

3. The lamp according to claim 1, wherein the substrate holding member includes a holding member body coming into contact with the globe at a distal end portion thereof.

4. The lamp according to claim 1, comprising power circuit units held by the respective substrates and configured to supply power to the light source units.

5. The lamp according to claim 4, wherein the power source circuit units are arranged on the substrates at positions in the vicinity of the cap in the direction of a lamp axis.

6. The lamp according to claim 1, wherein the substrate holding member includes a plurality of surface portions away from each other in the circumferential direction with respect to the lamp axis, and
the respective substrates are held in a state of being thermally connected to the respective surface portions.

7. The lamp according to claim 1, wherein the substrate holding member includes a hole portion communicating with the outside of the globe and configured to take outside air into the interior thereof.

8. The lamp according to claim 7, wherein the globe includes a communicating opening portion on a top portion, which corresponds to the other end portion, and
the hole portion is provided along a center portion of the substrate holding member and configured to communicate with a communicating opening portion.

9. The lamp according to claim 8, wherein the globe includes an opening portion positioned between the globe and the cap, and
the substrate holding member includes an opening communicating with the hole portion and the opening portion and constituting an air-ventilation air trunk.

10. A luminaire comprising:
a luminaire body having a socket; and
the bulb-shaped lamp according to claim 1 configured to be mounted in the socket.
